(19) United States
(12) Patent Application Publication
(10) Pub. No.: US 2015/0176626 A1
(43) Pub. Date: Jun. 25, 2015

(54) SCREW CONNECTION ELEMENT FOR A CRANE ROTARY CONNECTION

(71) Applicant: Manitowoc Crane Group France SAS, Dardilly Cedex (FR)

(72) Inventor: Oliver Titsch, Wilhelmshaven (DE)

(21) Appl. No.: 14/407,148

(22) PCT Filed: Apr. 17, 2013
(86) PCT No.: PCT/EP2013/058014

§ 371 Date: Dec. 11, 2014

(30) Foreign Application Priority Data
Jun. 11, 2012 (DE) 20 2012 005 707.3

(51) Int. Cl. F16B 33/06; F16B 39/22

(52) U.S. Cl. CPC F16B 33/06; F16B 39/22

(57) ABSTRACT

A screw connection element for connecting a rotatable working device to a mount via of a rotary connector includes at least one connection contact surface which lies on a seating surface of the rotary connector in order to establish the connection. The at least one connection contact surface includes a metal flake coating and a top coat which is joined to the metal flake coating.

The invention relates to a screw connection element for connecting a rotatable working device (e.g. a crane or mobile crane superstructure) to a mount (e.g. a crane or mobile crane undercarriage) by means of a rotary connector. The screw connection element comprises at least one connection contact surface which lies on a seating surface of the rotary connector in order to establish the connection. The connection contact surface has a metal flake coating and a top coat which is joined to the metal flake coating. The invention further relates to a screwed rotary connection system with a screw connection element and a separate top coat.

Until now, it has been standard practice to produce ball bearing or roller bearing slewing rings for establishing a rotating connection between a crane superstructure and crane undercarriage, for example, using uncoated (black/untreated) screws with or without washers. The screws are usually tightened by hand. Damage to the contact surfaces, i.e. the surfaces of the ball bearing or roller bearing slewing rings and/or the screw contact surface on the underside of the screw head goes unnoticed as a rule. As a result of damage, torque can be applied by the torque wrench and the torque wrench released without a required elongation of the screw being achieved due to the premature unnoticed consumption of energy in the contact clearance between the ball bearing and roller bearing slewing ring and the screw. The result is too low a mounting force, i.e. too low a clamping force of the connection.

Accordingly, it is an objective of the invention to propose a screw connection element or a screw connection system with a screw connection element which reliably guarantees that a desired elongation will be achieved on tightening and hence a predefined clamping force.

This objective is achieved by the invention due to the subject matter defined in claim 1 and the system defined in claim 11.

The invention relates to a screw connection element for connecting a rotatable working device to a mount by means of a rotary connector. The screw connection element has at least one connection contact surface which lies on the rotary connector or a part of the rotary connector in order to establish the rotary connection between the working device and the mount. On the at least one connection contact surface, the screw connection element has a metal flake coating and a top coat joined to the metal flake coating.

By top coat in this context is meant a coating by means of which the metal flake coating is covered, for example.

The screw connection element may be a screw with a screw head and a screw shaft. The screw shaft may have a first threadless region adjoining the screw head and a second region with an external thread adjoining it. The connection contact surface of the screw is formed by the underside of the screw head or the side of the screw head facing the screw shaft.

Alternatively, the screw connection element may be a washer for a screw. The washer has two potential connection contact surfaces, one for the screw and one for the seating surface. At least one of these two contact surfaces, preferably both of the contact surfaces, are provided with the metal flake coating with the top coat.

Since damage can occur both in the joint clearance between the screw head underside and washer and the washer and contact surfaces when fitting or tightening the screw, the washer is provided with the inventive coating on both sides as a rule. Whilst a coating on one side only could reduce the risk of a predefined elongation of the screw not being achieved, this could not be reliably ruled out.

The top coat comprises a substance or a means which guarantees a virtually constant coefficient of friction in a joint clearance between two metal parts. Consequently, it is a lubricant in the broadest sense, for example graphite, which forms a lubricating film in the joint clearance as the screw connection element is tightened.

The lubricant may be incorporated in a base compound or in capsules contained in the base compound, and the base compound and lubricant then form the top coat. The lubricant is not released until placed under pressure, thereby achieving the lubricating effect.

To work correctly, the screw connection element can be used once only. Re-use is not possible because there is no guarantee that the coefficient of friction in the joint clearance can be kept constant by the lubricating film working correctly. This means that a screw connection element proposed by the invention which has been used correctly to establish a rotary connection between a working device and a mount cannot be re-used and work correctly after the rotary connector has been demounted. To ensure that re-use is reliably prevented, the top coat may have coloured elements for example, which change colour or only become visible under the effect of pressure.

Adjusting the screw connection element in an existing connection, on the other hand, is permissible, at least within a specific period of time after establishing the connection. The time may be predefined depending on the nature of the top coat, for example.

To protect it against dirt and damage during transportation and/or in storage, the top coat may be covered by a removable protective film. The protective film may also be necessary to prevent the top coat from drying out. Especially in this case, but generally speaking as well, it may be expedient to issue a use-by date for the screw connection element in order to indicate to a user until when the screw connection element can be safely used. It may be preferable to print a fixed use-by date directly on the screw connection element, for example, and as this use-by date depends on the state of the top coat and/or the embedded lubricant, this could be indicated by a change in the colour of the top coat.

The invention further relates to a screw connection system, preferably for connecting a rotatable working device to a mount comprising at least one screw connection element having at least one connection contact surface which lies on the rotary connector in order to establish a connection to a seating surface, for example. The connection contact surface/s has/have a metal flake coating.

The screw connection system further comprises a substance which can be applied to the connection contact surface and/or seating surface by a fitter immediately before fitting and forms a top coat.

This separate top coat may be made available in the form of a pasty coating, preferably in tubes, in tins to be applied by means of a brush or as a coating which can be applied by an aerosol can. Directly before or during fitting, the coating is then applied by an experienced fitter to the metal flake coating of the screw connection element. The pastes, the coatings which can be applied by a brush and the sprayable coatings may contain volatile substrates and encapsulated lubricant. In this case, the coating preferably dries before the actual fitting operation, at least superficially, so that the coating cannot penetrate the bore for a screw or the counter-thread in the bore for the screw thread. Also falling within the scope of the invention is the fact that the separately supplied coating can also be applied to the seating surface for the screw on the rotary connector.

Finally, the coating may be provided in the form of a washer element, with or without a removable protective film to protect the top coat from dirt and/or damage and/or drying out.

An example of an embodiment of the invention will be described in more detail below with reference to the appended drawings, although the invention is not restricted to what is illustrated in the drawings. Advantageous features which can only be seen in the drawings and which enhance the invention individually or in the illustrated combinations also fall within the scope of the invention.

The drawings specifically illustrate the following:

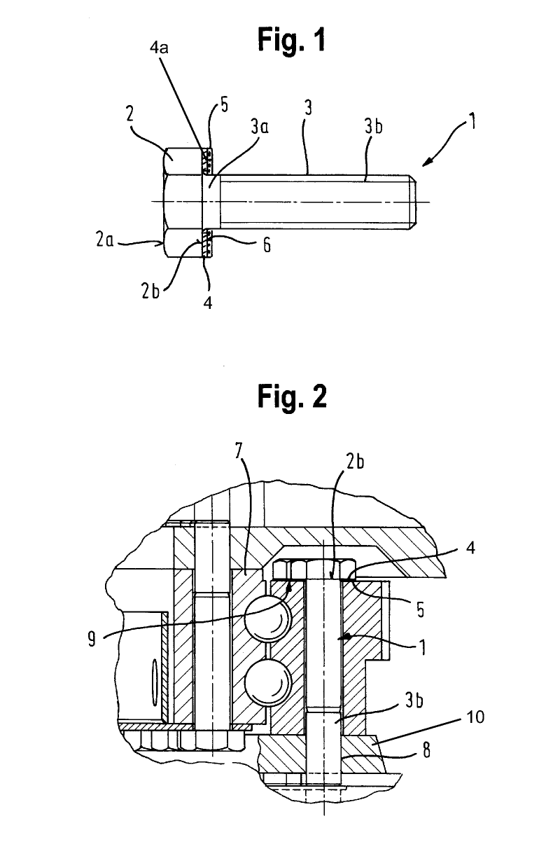

FIG. 1 a screw connection element based on the invention

FIG. 2 the screw connection element from FIG. 1 in a fitted situation.

FIG. 1 illustrates a screwed rotary connector element 1 in the form of a screw 1 with a screw head 2 and a screw shaft 3. The screw head 2 has a top face 2a and an underside 2b which forms a connection contact surface 2b of the screw 1 which lies on a seating surface with a view to establishing a connection. The screw shaft 3 has a first threadless portion 3a and a second threaded portion 3b with an external thread.

The connection contact surface 2b of the screw connection element 1 has a zinc flake coating 4 and a coating 5 or top coat 5, applied to the side 4a of the zinc flake coating 4 pointing away from the connection contact surface 2b in the embodiment illustrated as an example. The coating 5 incorporates capsules 6 containing a lubricant.

When the screw 1 is tightened, the capsules 6 are destroyed and the lubricant contained in them can escape and act in a contact clearance 9 between the connection contact surface 2b and the seating surface, not illustrated, for the connection contact surface 2b.

FIG. 2 illustrates the screw 1 from FIG. 1 in a fitted situation in which it connects a crane superstructure via a ball bearing slewing ring 7 to a crane undercarriage. The threaded portion 3b of the screw 1 partially engages by its thread in a counter-thread 8 formed in a component belonging to the crane undercarriage.

When the screw 1 is now tightened, the ball bearing slewing ring 7 is fixedly connected to the component of the crane undercarriage. In order to prevent the connection contact surface 2b from being damaged as the screw 1 is tightened, or to prevent the seating surface on the ball bearing slewing ring 7 from being damaged, which could lead to an increase in frictional forces in the joint clearance 9, the connection contact surface 2b has a zinc flake coating 4 with a coating 5. As the screw 1 is tightened, the coating 5 forms a lubricating film in the joint clearance 9, as a result of which a coefficient of friction in the joint clearance 9 is kept constant as far as possible.

This constant coefficient of friction enables a defined elongation of the screw 1 and as a result, at several screws 1 establishing the connection between a rotary connector 7 of a crane superstructure to a crane undercarriage, a clamping force of all the screws 1 with a low dispersion.

### LIST OF REFERENCE NUMBERS

1 Screw, screw connection element
2 Screw head
2a Top face
2b Underside, connection contact surface
3 Screw shaft
3a Threadless portion
3b Threaded portion
4 Zinc flake coating
5 Coating, top coat
6 Capsule
7 Ball bearing slewing ring, rotary connector
8 Counter-thread
9 Joint clearance

1. A screw connection element for connecting a rotatable working device to a mount via a rotary connector, comprising:
at least one connection contact surface which lies on a seating surface of the rotary connector in order to establish the connection, wherein
the at least one connection contact surface has a metal flake coating and a top coat which is joined to the metal flake coating.

2. The screw connection element as claimed in claim 1, wherein the screw connection element is a screw comprising a screw head and a screw shaft and wherein a side of the screw head facing the screw shaft is the connection contact surface.

3. The screw connection element as claimed in claim 1, wherein the screw connection element is a washer that includes two connection contact surfaces, at least one of the connection contact surfaces being provided with the metal flake coating and the top coat.

4. The screw connection element as claimed in claim 1, wherein the top coat comprises a lubricant which forms a lubricating film as the screw connection element is being tightened.

5. The screw connection element as claimed in claim 4, wherein the lubricant is embedded in a base compound and is not released until placed under pressure.

6. The screw connection element as claimed in claim 1, wherein the screw connection element is configured for a single use so that it cannot be used again and work correctly.

7. The screw connection element as claimed in claim 1, wherein the metal flake coating is a zinc flake coating.

8. The screw connection element as claimed in claim 1, wherein the rotary connector comprises at least one of a ball bearing and a roller bearing slewing ring of a crane, in particular a mobile crane.

9. The screw connection element as claimed in claim 1, wherein the rotatable working device is a crane and the screw connection element is a screw connection element for a crane slewing ring.

10. The screw connection element as claimed in claim 9, wherein the top coat is covered with a removable protective film affording protection against dirt during at least one transportation and storage of the screw connection element.

11. A screw connection system for connecting a rotatable working device to a mount via a rotary connector, comprising:
at least one screw connection element comprising at least one connection contact surface which lies on a seating surface of the rotary connector in order to establish a connection between the rotatable working device to the mount, wherein the at least one connection contact surface has a metal flake coating; and
a substance which can be applied by a fitter to at least one of the connection contact surface and the seating surface to form a top coat.

12. The screw connection system as claimed in claim 11, wherein the substance is provided in the form of a paste in at least one of a tube, a liquid in a tin, a spray, and as a separate washer element.

13. The screw connection system as claimed in claim 11, wherein the screw connection element is at least one of a screw and a washer.

14. The screw connection system as claimed in claim 11, wherein the top coat comprises a lubricant which forms a lubricating film as the screw connection element is being tightened.

15. The screw connection element as claimed in claim 4, wherein the lubricant is graphite.

16. The screw connection element as claimed in claim 4, wherein the lubricating film provides an essentially constant coefficient of friction in a joint clearance between the connection contact surface and the seating surface.

17. The screw connection element as claimed in claim 5, wherein the base compound and the lubricant form the top coat.

18. The screw connection system as claim in claim 12, further comprising a protective film configured to cover the substance.

19. The screw connection system as claimed in claim 14, wherein the lubricant is embedded in a base compound and is not released until placed under pressure.

20. The screw connection system as claimed in claim 11, wherein the rotatable working device is a crane and the screw connection element is a screw connection element for a crane slewing ring.

21. The screw connection system as claimed in claim 11, wherein the screw connection element is configured for a single use so that it cannot be used again and work correctly.

22. The screw connection system as claimed in claim 11, wherein the metal flake coating is a zinc flake coating.

23. The screw connection system as claimed in claim 11, wherein the rotary connector comprises at least one of a ball bearing and a roller bearing slewing ring of a crane, in particular a mobile crane.
